(19) United States
(12) Patent Application Publication
(10) Pub. No.: US 2014/0186786 A1
(43) Pub. Date: Jul. 3, 2014

(54) CONTINUOUS FIRING FURNACE

(71) Applicants: Kazumi Mori, Kagamihara-shi (JP); Yoshiyasu Matsuda, Kagamihara-shi (JP); Yukio Kuroda, Kagamihara-shi (JP); Tatsuto Kaneko, Kagamihara-shi (JP)

(72) Inventors: Kazumi Mori, Kagamihara-shi (JP); Yoshiyasu Matsuda, Kagamihara-shi (JP); Yukio Kuroda, Kagamihara-shi (JP); Tatsuto Kaneko, Kagamihara-shi (JP)

(21) Appl. No.: 14/126,196

(22) PCT Filed: Jun. 14, 2012
(86) PCT No.: PCT/JP2012/065258

§ 371 Date: Dec. 13, 2013

(30) Foreign Application Priority Data
Jul. 4, 2011 (JP) 2011-147899

(51) Int. Cl. F27D 99/00; F27B 9/22

(52) U.S. Cl. CPC F27D 99/00; F27B 9/22
USPC 432/88; 432/128

(57) ABSTRACT

The continuous firing furnace includes: a single or a plurality of heating units (120), each of which includes a casing (120b) provided with a through-hole (120a) in a transport direction of a material to be heated, a heating section (160) that heats the material to be heated, and a movable section (150) that is provided at a lower portion of the casing and that supports and allows the casing to move in a horizontal direction, wherein through-holes are formed so as to be able to communicate with each other in the transport direction; a single or a plurality of cooling units (122) configured to cool the material to be heated, each of which includes a casing (122b) provided with a through-hole (122a) in the transport direction of the material to be heated, and a cooling section (170) that cools the material to be heated, wherein through-holes are formed so as to be able to communicate with the through-holes of the plurality of heating units; and a pressing section (124) configured to press the single or the plurality of heating units and the single or the plurality of cooling units in the transport direction. The heating units, and the heating unit and the cooling unit are connected to each other by pressing of the pressing section.

### TECHNICAL FIELD

The present invention relates to a continuous firing furnace which continuously heats materials to be heated. Priority is claimed on Japanese Patent Application No. 2011-147899, filed Jul. 4, 2011, the contents of which are incorporated herein by reference.

### BACKGROUND ART

Conventionally, there is a continuous firing furnace that heats materials to be heated which are continuously transported in the furnace. With regard to such a continuous firing furnace, a technology is disclosed in which a door is provided between a heating chamber and a cooling chamber in the continuous firing furnace, thereby suppressing heat transfer from the heating chamber to the cooling chamber (for example, Patent Document 1).

Further, a heat treatment apparatus is proposed in which a slide device is provided as a base of support legs supporting an opening and closing door and then the opening and closing door is slid to be opened and closed (for example, Patent Document 2). In addition, a continuous heat treatment furnace is also proposed in which heater blocks connected to each other in the longitudinal direction of the furnace are provided around a muffle and the muffle and the heater blocks can move on rails using casters (for example, Patent Document 3).

### DOCUMENT OF RELATED ART

### Patent Document

[Patent Document 1] Japanese Unexamined Patent Application, First Publication No. 2002-130956

[Patent Document 2] Japanese Unexamined Patent Application, First Publication No. 2004-250782

[Patent Document 3] Japanese Unexamined Patent Application, First Publication No. 2010-151369

### SUMMARY OF INVENTION

### Technical Problem

A continuous firing furnace is configured by connecting units together each having a furnace length of, for example, about 1 m. When performing maintenance on the inside of the furnace, the unit which is a target of the maintenance has to be removed from the units connected to the front and back thereof. Further, since the weight of the unit is great, for example, a heavy machine has to be used in order to move the unit.

Further, in a conventional continuous firing furnace which includes the firing furnace described in Patent Document 1 described above, furnace legs are fixed to the ground by foundation bolts or the like. Therefore, in order to move the unit, all the foundation bolts fixing the unit have to be removed. Consequently, the conventional continuous firing furnace has significantly low maintainability.

In addition, in a case of changing a firing pattern by changing the heating time, the heating temperature, the cooling time, the tact time, and the like of the continuous firing furnace, at the time of addition or removal of the unit, similar to the time of the maintenance, the removal of foundation bolts, the use of a heavy machine, or the like is required, and thus the workability is low.

Even if the slide device of the opening and closing door disclosed in Patent Document 2 described above is provided in the continuous firing furnace, the movement of the unit does not become easy, and thus the maintainability is not improved. Further, as in Patent Document 3, in a configuration in which a support member of the muffle is provided with casters, even if it is easy to move the muffle and the heater blocks together, the movement of each heater block for maintenance or the like is difficult.

The present invention aims to provide a continuous firing furnace which has high maintainability and in which a change of a firing pattern is easy, in view of the problems described above.

### Solution to Problem

In order to solve the above problems, according to a first aspect of the present invention, a continuous firing furnace includes: a single or a plurality of heating units, each of which includes a casing provided with a through-hole in a transport direction of a material to be heated, a heating section that heats the material to be heated, and a movable section that is provided at a lower portion of the casing and that supports and allows the casing to move in a horizontal direction, wherein through-holes are formed so as to be able to communicate with each other in the transport direction; a single or a plurality of cooling units configured to cool the material to be heated, each of which includes a casing provided with a through-hole in the transport direction of the material to be heated, and a cooling section that cools the material to be heated, wherein through-holes are formed so as to be able to communicate with the through-holes of the plurality of heating units; and a pressing section configured to press the single or the plurality of heating units and the single or the plurality of cooling units in the transport direction. In addition, the heating units, and the heating unit and the cooling unit are connected to each other by pressing of the pressing section.

According to a second aspect of the present invention, in the first aspect, each of the single or the plurality of cooling units further includes a movable section which is provided at a lower portion of the casing thereof and which supports and allows the casing to move in the horizontal direction. In addition, the cooling units, and the heating unit and the cooling unit are connected to each other by the pressing of the pressing section.

According to a third aspect of the present invention, in the first or second aspect, a connecting portion between the heating units, between the cooling units, or between the heating unit and the cooling unit does not include a fastening structure.

According to a fourth aspect of the present invention, in any one of the first aspect to the third aspect, at least one of connecting portions between the heating units, between the cooling units, and between the heating unit and the cooling unit includes a recess portion having a recess shape at an end portion on one side thereof and a projection portion having a projection shape at an end portion on the other side thereof. In addition, the recess portion and the projection portion have a fitting structure.

According to a fifth aspect of the present invention, in the fourth aspect, each of fitting parts of the recess portion of the end portion on the one side and the projection portion of the end portion on the other side is formed into a taper structure including an inclined surface having an inclination angle of more than 0 degrees toward the transport direction.

According to a sixth aspect of the present invention, in the fourth or fifth aspect, in a state where the recess portion of the end portion on the one side and the projection portion of the end portion on the other side are fitted to each other in a connecting portion, an inner peripheral surface of the recess portion and an outer peripheral surface of the projection portion, which face each other, are disposed so as to be separated from each other.

According to a seventh aspect of the present invention, in any one of the first aspect to the sixth aspect, a seal material is provided in a circumferential direction at each of connecting portions between the heating units, between the cooling units, and between the heating unit and the cooling unit.

### EFFECTS OF INVENTION

The present invention can provide a continuous firing furnace which has high maintainability and in which a firing pattern can be easily changed.

### BRIEF DESCRIPTION OF DRAWINGS

FIG. 1 is a top view of a continuous firing furnace.

FIG. 2A is a cross-sectional view of the continuous firing furnace, showing a cross section along line A-A of FIG. 1.

FIG. 2B is a cross-sectional view of the continuous firing furnace, showing a cross section along line B-B of FIG. 1.

FIG. 3A is an explanatory diagram which shows the shape of a connecting portion between units and is a cross-sectional view along line A-A of FIG. 1 in a state where two heating units are connected to each other.

FIG. 3B is an explanatory diagram which shows the shape of a connecting portion between units and is a cross-sectional view along line A-A of FIG. 1 in a state where two heating units are spaced apart from each other in a transport direction.

FIG. 3C is an explanatory diagram which shows the shape of a connecting portion between units and is a cross-sectional view along line A-A of FIG. 1 in a state where two heating units are connected to each other.

FIG. 3D is an explanatory diagram which shows the shape of a connecting portion between units and is a cross-sectional view along line A-A of FIG. 1 in a state where two heating units are spaced apart from each other in a transport direction.

FIG. 3E is an explanatory diagram which shows the shape of a connecting portion between units and is an enlarged view of FIG. 3D.

FIG. 4 is a cross-sectional view of the continuous firing furnace at the time of maintenance.

FIG. 5A is an explanatory diagram which shows a firing pattern.

FIG. 5B is an explanatory diagram which shows a firing pattern.

FIG. 5C is an explanatory diagram which shows a firing pattern.

FIG. 6 is a cross-sectional view along line A-A of FIG. 1 in a modification.

### DESCRIPTION OF EMBODIMENTS

Hereinafter, a preferred embodiment of the present invention will be described in detail with reference to the accompanying drawings. Dimensions, materials, other specific numerical values, and the like shown in the embodiment are only exemplary examples which facilitate understanding of the present invention and are not intended to limit the present invention except a case where special description to limit it is provided. In addition, in this specification and the drawings, with respect to elements having substantially the same function and configuration, the same reference sign is applied thereto and overlapping descriptions are omitted, and with respect to elements which are not directly related to the present invention, the illustrations thereof are omitted.

In this embodiment, with respect to continuous firing furnaces 100 and 200 which fire ceramic or graphite mainly at a high temperature greater than or equal to 2000° C., a configuration which has high maintainability and which facilitates a change of a firing pattern will be described in detail.

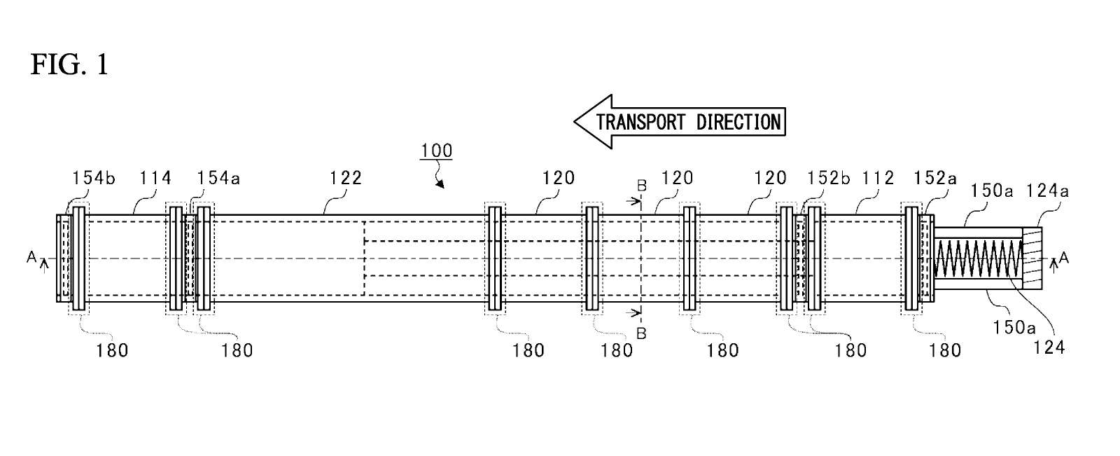

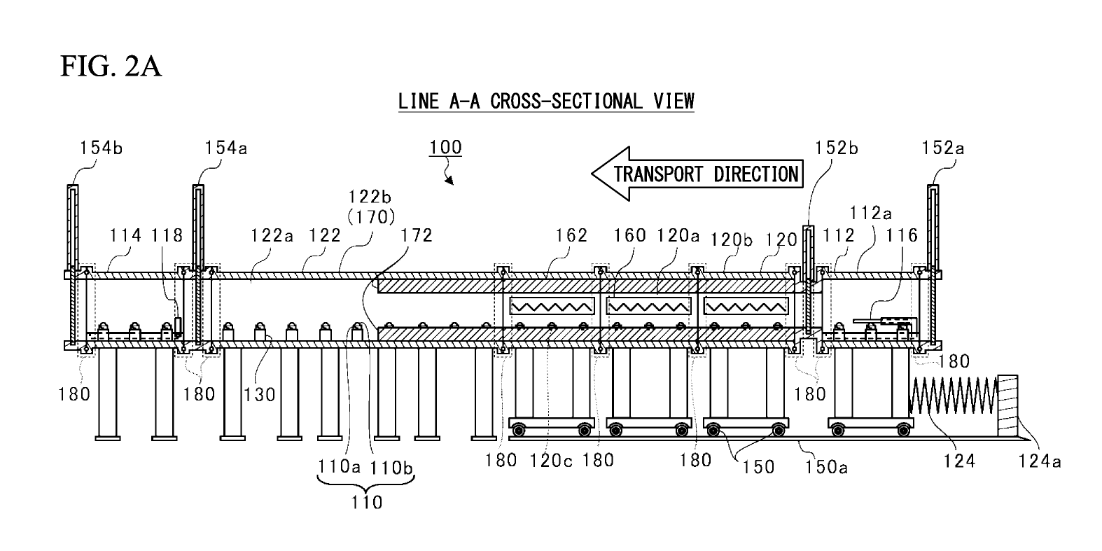

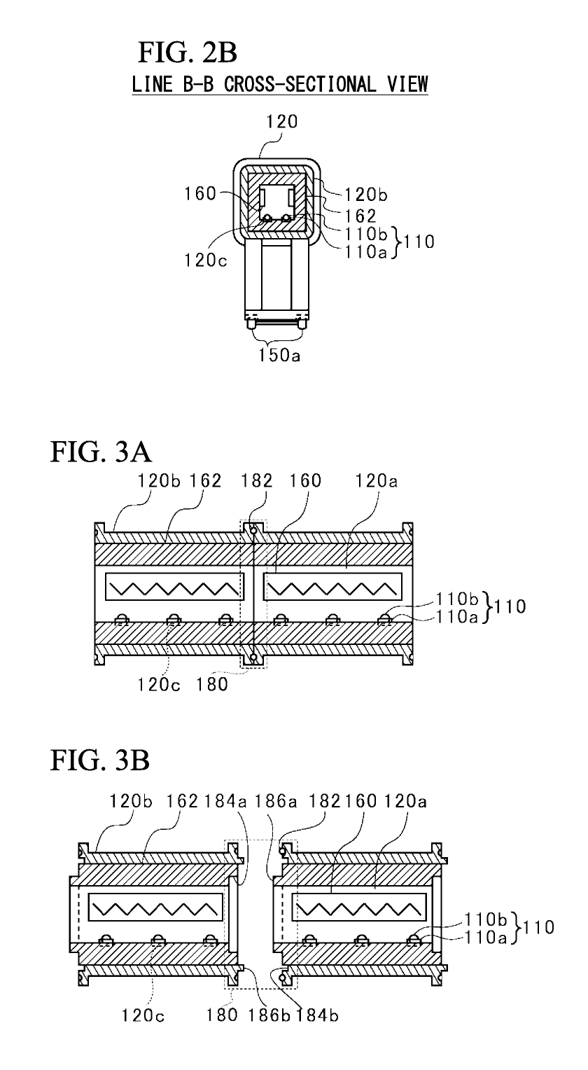

FIG. 1 is a top view of the continuous firing furnace 100, and FIGS. 2A and 2B are cross-sectional views of the continuous firing furnace 100. FIG. 2A shows a cross section along line A-A of FIG. 1, and FIG. 2B shows a cross section along line B-B of FIG. 1.

As shown in FIG. 2A, the continuous firing furnace 100 includes free rollers 110, a carry-in and degassing unit 112, a carry-out and degassing unit 114, a pusher device 116, a puller device 118, heating units 120, a cooling unit 122, and a pressing section 124.

Each of the free rollers 110 is configured to include a support section 110a and a roller 110b rotatably held in a holding hole provided in the support section 110a. In the carry-in and degassing unit 112, the cooling unit 122, and the carry-out and degassing unit 114, the free rollers 110 are rotatably supported by the upper ends of support posts 130 erected on the bottom surface of the inside of each furnace. Further, in the heating units 120, the free rollers 110 are not provided in the support posts 130 but are fitted into lower holes 120c provided in the bottom surface of the inside of each furnace.

The free rollers 110 are provided in each line so as to form two lines in a transport direction in each unit (each of the carry-in and degassing unit 112, the heating units 120, the cooling unit 122, and the carry-out and degassing unit 114), and transportably support a tray (not shown) with a material to be heated placed thereon.

Further, the free rollers 110 are disposed such that the tops of the rollers 110b between adjacent units have the same level, in a state where all the units are connected as the continuous firing furnace 100. Therefore, the tray with the material to be heated placed thereon can slide on the free rollers 110 without rocking.

The carry-in and degassing unit 112 is located on the upstream side (the right side in FIGS. 1 and 2A) in the transport direction of the tray with respect to the heating units 120, and the carry-out and degassing unit 114 is located on the downstream side (the left side in FIGS. 1 and 2A) in the transport direction of the tray with respect to the cooling unit 122. The atmospheres in the carry-in and degassing unit 112 and the carry-out and degassing unit 114 are maintained at predetermined atmospheres (for example, non-oxidizing atmosphere such as nitrogen gas, argon gas, halogen gas, or a vacuum) by an atmosphere retention and replacement device (not shown).

Further, the carry-in and degassing unit 112 includes a movable section 150. The movable section 150 is configured to include, for example, casters (wheels) and supports and allows a casing 112a of the carry-in and degassing unit 112 to move in a horizontal direction at a lower portion of the casing 112a. In this embodiment, the movable section 150 is placed on two rails 150a disposed on a floor in the transport direction, and the casing 112a can move on the rails 150a.

In addition, the carry-in and degassing unit 112 includes opening and closing doors 152a and 152b which vertically move up and down, to be opened and closed. Further, when the opening and closing doors 152a and 152b move down (are closed), the inside of the carry-in and degassing unit 112 becomes an airtight chamber. Similarly, the carry-out and degassing unit 114 includes opening and closing doors 154a and 154b. Further, when the opening and closing doors 154a and 154b move down, the inside of the carry-out and degassing unit 114 becomes an airtight chamber. When the opening and closing doors 152a, 152b, 154a, and 154b move up (are opened), carry-in and carry-out of the tray are possible.

When the tray with the material to be heated placed thereon is disposed on the free rollers 110 in the carry-in and degassing unit 112, the pusher device 116 pushes the tray in the transport direction. In this way, the pusher device 116 advances the tray and carries the tray into the heating unit 120. The puller device 118 pulls the tray with the material to be heated placed thereon from the free rollers 110 in the cooling unit 122 and carries the tray out to the carry-out and degassing unit 114.

In this embodiment, the pusher device 116 continuously carries one tray into the furnace every predetermined time (tact time). Then, the tray previously carried into the furnace is pushed by the tray subsequently carried thereinto each time another tray is carried into the furnace, and horizontally moves in the transport direction. Further, the puller device 118 carries the tray which is pushed out, out from the cooling unit 122 at the timing which is synchronous with the pusher device 116.

As a result, the material to be heated placed on the tray is intermittently transported in the continuous firing furnace 100 by a predetermined stroke corresponding to the width of the tray every tact time.

Each of the heating units 120 includes a casing 120b provided with a through-hole 120a in the transport direction of the material to be heated, and the through-holes 120a of the heating units 120 are formed so as to be able to communicate with each other in the heating units 120.

Further, the heating unit 120 includes a movable section 150, a heating section 160, a heat insulation section 162, and free rollers 110.

The movable section 150 is configured to include, for example, casters, similar to the carry-in and degassing unit 112, and supports and allows the casing 120b to move in the horizontal direction at a lower portion of the casing 120b.

The heating section 160 is configured to include a resistance heater, a gas heater, a burner, or the like and heats the material to be heated which moves inside the through-hole 120a.

The heat insulation section 162 has excellent heat insulating properties and heat resistance properties, covers the inner periphery of the through-hole 120a of the heating unit 120, and suppresses heat radiation from the inside of the furnace to the outside thereof.

The cooling unit 122 includes a casing 122b provided with a through-hole 122a in the transport direction of the material to be heated, similar to the heating unit 120, and the through-hole 122a is formed so as to be able to communicate with a through-hole of another unit such as, for example, the through-hole 120a of the heating units 120.

Further, the cooling unit 122 includes a cooling section 170 and a heat insulation section 172. In this embodiment, the cooling section 170 is the casing 122b of the cooling unit 122 and radiates heat in the furnace to the outside of the furnace, thereby lowering the internal temperature of the furnace and cooling the material to be heated.

The heat insulation section 172 has excellent heat insulating properties and heat resistance properties, similar to the heat insulation section 162. The heat insulation section 172 covers the inner periphery of the through-hole 122a of the cooling unit 122 and suppresses heat radiation from the inside of the furnace to the outside thereof, thereby decreasing the rate of fall in the temperature of the material to be heated. Using a configuration in which the continuous firing furnace 100 includes the heat insulation section 172, it is possible to prevent occurrence of cracks or the like of the material to be heated.

Further, the heating unit 120 and the cooling unit 122 communicate with the carry-in and degassing unit 112 and with the carry-out and degassing unit 114 respectively, and when the opening and closing doors 152b and 154a move down, to be closed, the heating unit 120 and the cooling unit 122 become airtight chambers. Further, the atmospheres in the heating unit 120 and the cooling unit 122 are maintained at predetermined atmospheres equivalent to those of the carry-in and degassing unit 112 and the carry-out and degassing unit 114 by an atmosphere retention and replacement device (not shown).

The pressing section 124 is configured to include, for example, a cylinder (an air cylinder or a hydraulic cylinder), a coil spring, or the like and presses the heating units 120 and the single cooling unit 122 in the transport direction.

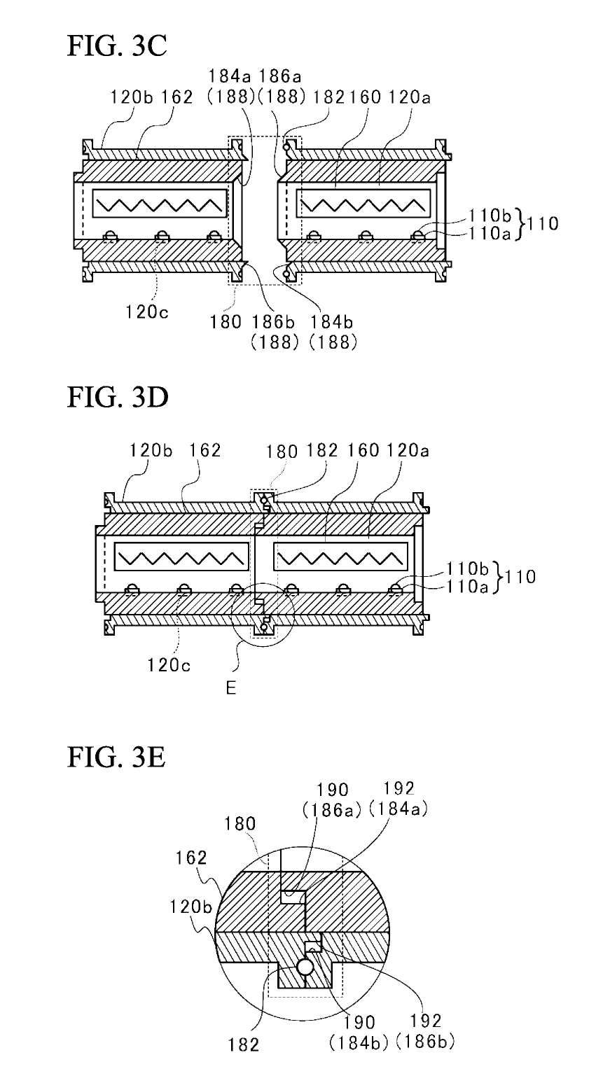

FIGS. 3A to 3E are explanatory diagrams which show the shapes of a connecting portion 180 between units. FIGS. 3A to 3D show cross-sectional views along line A-A of FIG. 1 of two adjacent heating units 120 except for the movable sections 150. FIG. 3E is an enlarged view of a circle E in FIG. 3D. In addition, in order to facilitate understanding of the shapes, FIGS. 3A and 3D show a state where the two heating units 120 are connected to each other. Further, FIGS. 3B and 3C show a state where the two heating units 120 are spaced apart from each other in the transport direction.

As shown in FIG. 3A, in this embodiment, the connecting portion 180 (shown by a dashed quadrangle, a contact portion of end faces between units) between the heating units 120 is in a contact state in a plane and does not have a fastening structure. Then, the connecting portion 180 is in a connected state by the pressing of the pressing section 124 described above. FIGS. 3A to 3E show the connecting portion 180 between the heating units 120, but the connecting portions 180 between the carry-in and degassing unit 112 and the heating unit 120 and between the heating unit 120 and the cooling unit 122 also have the same configuration.

For example, if the outer peripheral part of the connecting portion 180 has flanges and the flanges are connected by bolting (fastening structure), a welded portion or the like between the flange and the casing may be broken due to the thermal expansion in the transport direction of a joined portion. However, in the continuous firing furnace 100 of this embodiment, the connecting portion 180 is not provided with a fastening structure and the connection thereof is performed by the pressing of the pressing section 124. Therefore, in the continuous firing furnace 100, the thermal expansion in the transport direction can be canceled by contraction of the pressing section 124. As a result, it is possible to prevent breakage of a welded portion or the like of the flange. In a case where the flanges are not fastened by bolts, units may be aligned using, for example, a pin at the time of connection of the units.

Further, in this embodiment, all the connecting portions 180 do not have a fastening structure such as bolting and are in a connected state by the pressing of the pressing section 124. However, for example, at least one connecting portion 180 may not have a fastening structure such as bolting and may be in a connected state by the pressing of the pressing section 124. In this case, in the connecting portion 180 in which connection is performed by pressing of the pressing section 124, it is possible to prevent breakage of a welded portion or the like of the flange.

Further, at the connecting portion 180, a seal material 182 is provided in the circumferential direction thereof. Using a configuration in which the connecting portions 180 include the seal material 182, the inside of the furnace can be easily made as a hermetically-sealed structure. In this case, it becomes possible to also perform heating treatment to, for example, graphite or the like which requires an inert gas atmosphere inside the furnace in order to prevent oxidation.

Further, at least one of the connecting portions 180 between the carry-in and degassing unit 112 and the heating unit 120, between the heating units 120, and between the heating unit 120 and the cooling unit 122 is not limited to a structure of being in contact in a plane. As shown in FIG. 3B, a structure may be adopted in which an end portion on one side of the connecting portion 180 includes a recess portion 184a or 184b having a recess shape, an end portion on the other side of the connecting portion 180 includes a projection portion 186a or 186b having a projection shape, and the recess portion 184a or 184b and the projection portion 186a or 186b are fitted to each other.

In a case where the above-described fitting structure is formed, it becomes possible to easily and accurately perform positioning between the units such that end portions of the through-holes 120a and 122a to be connected are at positions overlapping with each other.

In this embodiment, in the connecting portion 180, the recess portion 184a and the projection portion 186a are provided at end portions of the heat insulation sections 162 and the recess portion 184b and the projection portion 186b are provided at flange portions. That is, two sets of recess portions and projection portions are provided in the connecting portion 180. However, one set of a recess portion and a projection portion may be provided, and three sets or more of recess portions and projection portions may be provided.

Further, as shown in FIG. 3C, fitting parts of the recess portion 184a or 184b of the end portion on one side of the connecting portion 180 and the projection portion 186a or 186b of the end portion on the other side of the connecting portion 180 may have taper structures. That is, the recess portions 184a and 184b and the projection portions 186a and 186b may be formed as taper structures each having an inclined surface 188 having an inclination angle of more than 0 degrees toward the transport direction.

In a case where the above-described taper structures are formed, when units are connected to each other, since the taper structures are fitted to each other while acting as guides and lead the units to the correct positions, positioning between units is more easily performed. Further, even if thermal expansion occurs in a plane direction perpendicular to the transport direction, the heating unit 120 or the cooling unit 122 is shifted in the transport direction. In this way, the pressing section 124 can cancel the displacement corresponding to the expansion. As a result, it is possible to prevent breakage of the recess portions 184a and 184b.

Further, as shown in FIGS. 3D and 3E, in the connecting portion 180, in a state where the recess portions 184a and 184b of the end portion on one side thereof and the projection portions 186a and 186b of the end portion on the other side are fitted to each other, an inner peripheral surface 190 of each of the recess portions 184a and 184b and an outer peripheral surface 192 of each of the projection portions 186a and 186b, which face each other, may be disposed so as to be separated from each other.

In a case of forming a structure in which the inner peripheral surface 190 of each of the recess portions 184a and 184b and the outer peripheral surface 192 of each of the projection portions 186a and 186b are separated from each other and a gap is provided therebetween, the recess portions 184a and 184b or the projection portions 186a and 186b can cancel thermal expansion in the plane direction perpendicular to the transport direction. As a result, it is possible to prevent breakage of the recess portions 184a and 184b.

As described above, the connecting portion 180 does not have a fastening structure such as bolting and is in a connected state by pressing of the pressing section 124. Therefore, by simply moving the carry-in and degassing unit 112 and the heating unit 120 in the horizontal direction along the rails 150a without releasing a fastening structure of the connecting portion 180, it is possible to extend and retract the pressing section 124. In addition, it is possible to separate any of the portions between the heating units 120 and the portion between the carry-in and degassing unit 112 and the heating unit 120.

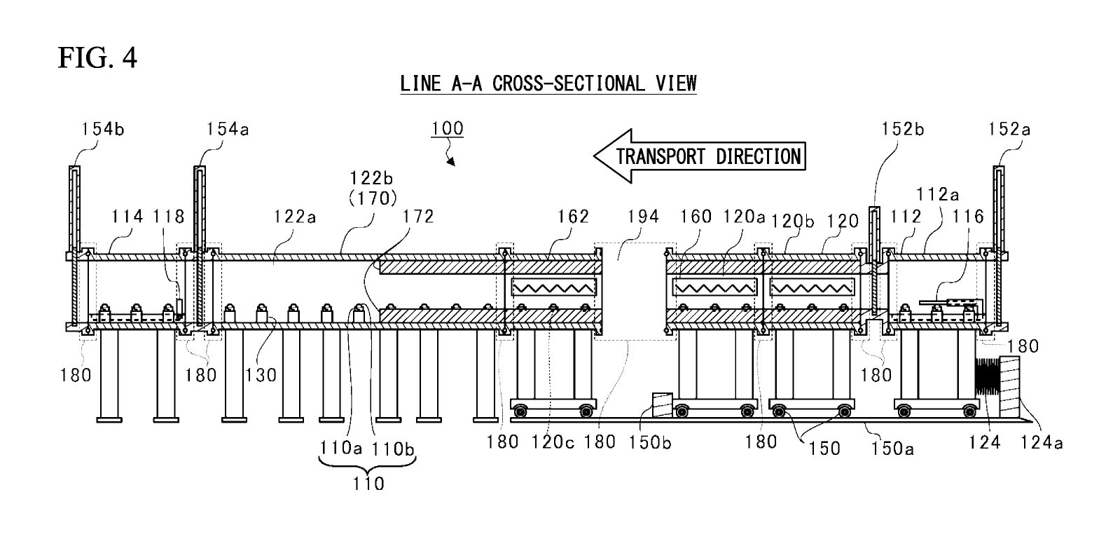

FIG. 4 is a cross-sectional view of the continuous firing furnace 100 at the time of maintenance. FIG. 4 shows a cross-sectional view corresponding to a cross section along line A-A of FIG. 1 at the time of maintenance. For example, as shown in FIG. 4, the movable section 150 is fixed by a detachable stopper 150b or the like in a state where a space 194 is formed between the heating units 120. In this way, it becomes possible for a worker to easily perform maintenance inside a furnace of the heating unit 120 through the space 194 between the heating units 120. That is, the continuous firing furnace 100 of this embodiment has high maintainability.

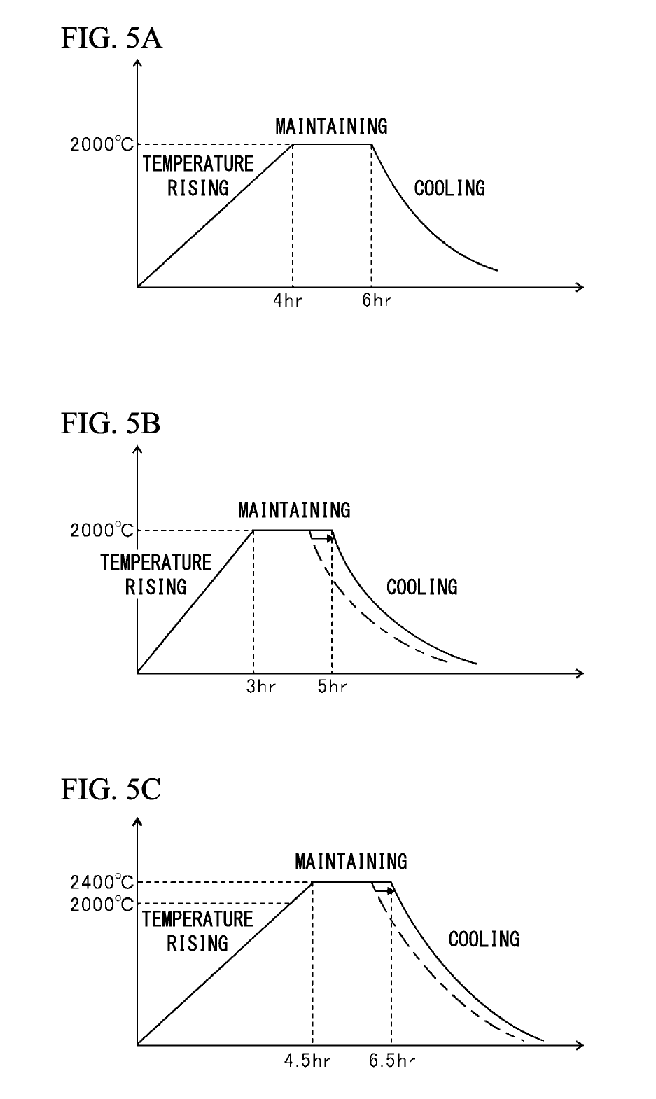

FIGS. 5A to 5C are explanatory diagrams which show firing patterns. In FIGS. 5A to 5C, the horizontal axis shows time and the vertical axis shows the temperature of the surface of the material to be heated which is transported and heated in the inside of the continuous firing furnace 100.

Compared to the firing pattern shown in FIG. 5A, FIG. 5B shows an example of a firing pattern in a case where, for example, the heating output of the heating section 160 is increased and tact time is shortened to increase a throughput per time. In a case where it is necessary to maintain a temperature of 2000 degrees for two hours, if only the tact time is shortened, as shown by an alternate long and short dash line in FIG. 5B, the time for which the temperature is maintained at 2000 degrees becomes short. In this case, in the continuous firing furnace 100, the number of the heating units 120 is increased, and thereby the time the temperature is maintained at 2000 degrees is set to be two hours (refer to a solid line in FIG. 5B).

Further, compared to the firing pattern shown in FIG. 5A, FIG. 5C shows an example of a firing pattern changed such that, without changing the tact time, for example, the heating temperature is increased to 2400 degrees and the temperature is then maintained for two hours. In this case, if the temperature of the heating section 160 is merely raised, as shown by an alternate long and short dash line in FIG. 5C, the time the temperature is maintained at 2400 degrees is reduced by the time corresponding to an increase in the time taken to raise the temperature. In this case, in the continuous firing furnace 100, the number of the heating units 120 is increased, and thereby the time the temperature is maintained at 2400 degrees is set to be two hours (refer to a solid line in FIG. 5C).

As described above, the firing pattern may be modified by changing the heating time, the heating temperature, the cooling time, the tact time, and the like of the continuous firing furnace 100. In the continuous firing furnace 100 of this embodiment, the pressing section 124 can be removed at the time of addition or removal of the heating unit 120. In this way, it is possible to sequentially pull the heating units 120 out from the end portion of the rails 150a. In the continuous firing furnace 100, it is also possible to easily add the heating unit 120, as necessary.

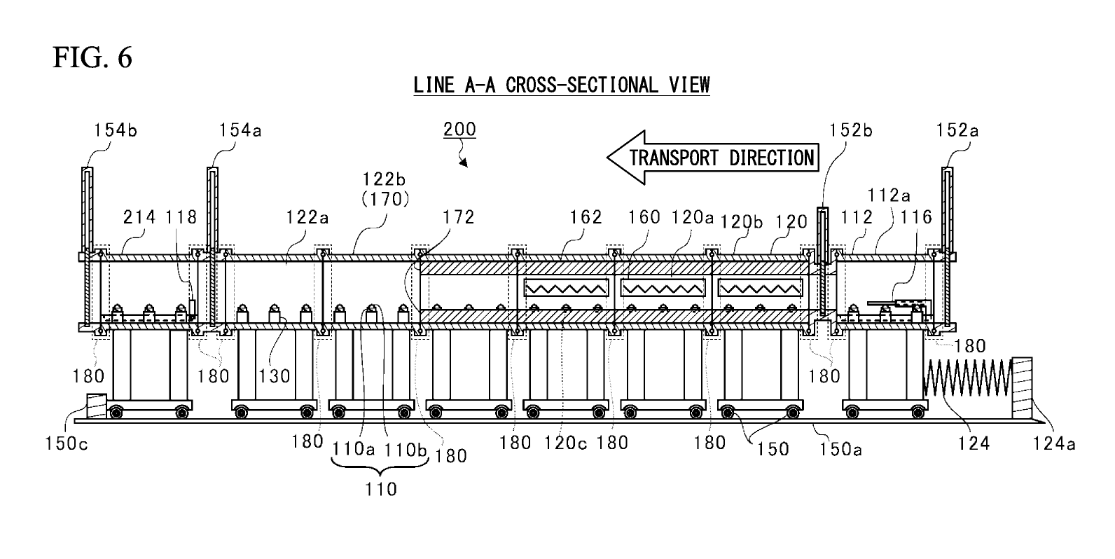

FIG. 6 is a cross-sectional view along line A-A of FIG. 1 in a modification of this embodiment. FIG. 6 shows a cross-sectional view of the continuous firing furnace 200 corresponding to the line A-A cross-sectional view of the continuous firing furnace 100 described above.

As shown in FIG. 6, in the continuous firing furnace 200, not only the carry-in and degassing unit 112 or the heating units 120, but also cooling units 222 and a carry-out and degassing unit 214 include movable sections 150. The movable section 150 of the carry-out and degassing unit 214 is fixed by, for example, a detachable stopper 150c or the like.

The continuous firing furnace 200 includes a plurality of cooling units 222, unlike the continuous firing furnace 100. The through-holes 122a of the cooling units 222 are formed so as to be able to communicate with each other in the cooling units 222.

Further, a fastening structure is not used at portions between all the units including a portion between the cooling units 222 and a portion between the heating unit 120 and the cooling unit 222. Each pair of units are connected to each other by pressing of the pressing section 124.

Using the above configuration, in the continuous firing furnace 200, a space can also be formed between the cooling units 222. Therefore, maintenance inside a furnace of the cooling unit 222 is also easily performed. Further, addition or removal of the cooling unit 222 also becomes possible, and thus it is possible to increase the degree of freedom of the change of the firing pattern.

The preferred embodiment of the present invention has been described above with reference to the accompanying drawings. However, the present invention is not limited to the above embodiment. The shapes, the combination, or the like of the constituent members shown in the embodiment described above are illustrations and various changes can be made based on design requirements or the like within a scope which does not depart from the gist of the present invention.

For example, each of the continuous firing furnaces 100 and 200 may include one heating unit 120 and one cooling unit.

### INDUSTRIAL APPLICABILITY

According to the present invention, it is possible to provide a continuous firing furnace which has high maintainability and in which a firing pattern can be easily changed.

### REFERENCE SIGNS LIST

100, 200 continuous firing furnace
120 heating unit
120a through-hole of heating unit
120b casing of heating unit
122, 222 cooling unit
122a through-hole of cooling unit
122b casing of cooling unit
124 pressing section
150 movable section
160 heating section
162 heat insulation section
170 cooling section
180 connecting portion
182 seal material
184a, 184b recess portion
186a, 186b projection portion
188 inclined surface
190 inner peripheral surface
192 outer peripheral surface

1. A continuous firing furnace comprising:
a single or a plurality of heating units, each of which includes a casing provided with a through-hole in a transport direction of a material to be heated, a heating section that heats the material to be heated, and a movable section that is provided at a lower portion of the casing and that supports and allows the casing to move in a horizontal direction, wherein through-holes are formed so as to be able to communicate with each other in the transport direction;
a single or a plurality of cooling units configured to cool the material to be heated, each of which includes a casing provided with a through-hole in the transport direction of the material to be heated, and a cooling section that cools the material to be heated, wherein through-holes are formed so as to be able to communicate with the through-holes of the plurality of heating units; and
a pressing section configured to press the single or the plurality of heating units and the single or the plurality of cooling units in the transport direction,
wherein the heating units, and the heating unit and the cooling unit are connected to each other by pressing of the pressing section.

2. The continuous firing furnace according to claim 1,
wherein each of the single or the plurality of cooling units further includes a movable section which is provided at a lower portion of the casing thereof and which supports and allows the casing to move in the horizontal direction, and
the cooling units, and the heating unit and the cooling unit are connected to each other by the pressing of the pressing section.

3. The continuous firing furnace according to claim 1,
wherein a connecting portion between the heating units, between the cooling units, or between the heating unit and the cooling unit does not include a fastening structure.

4. The continuous firing furnace according to claim 1,
wherein at least one of connecting portions between the heating units, between the cooling units, and between the heating unit and the cooling unit includes a recess portion having a recess shape at an end portion on one side thereof and a projection portion having a projection shape at an end portion on the other side thereof, and the recess portion and the projection portion have a fitting structure.

5. The continuous firing furnace according to claim 4,
wherein each of fitting parts of the recess portion of the end portion on the one side and the projection portion of the end portion on the other side is formed into a taper structure including an inclined surface having an inclination angle of more than 0 degrees toward the transport direction.

6. The continuous firing furnace according to claim 4,
wherein in a state where the recess portion of the end portion on the one side and the projection portion of the end portion on the other side are fitted to each other in a connecting portion, an inner peripheral surface of the recess portion and an outer peripheral surface of the projection portion, which face each other, are disposed so as to be separated from each other.

7. The continuous firing furnace according to claim 1,
wherein a seal material is provided in a circumferential direction at each of connecting portions between the heating units, between the cooling units, and between the heating unit and the cooling unit.
